(19) United States
(12) Patent Application Publication
(10) Pub. No.: US 2012/0298655 A1
(43) Pub. Date: Nov. 29, 2012

(54) MICROWAVE COOKING DEVICE

(76) Inventors: Yasuhiko Kamii, Osaka-shi (JP); Mitsuo Hirooka, Osaka-shi (JP)

(21) Appl. No.: 13/575,528

(22) PCT Filed: Jan. 25, 2011
(86) PCT No.: PCT/JP2011/051273

§ 371 Date: Jul. 26, 2012

(30) Foreign Application Priority Data
Feb. 3, 2010 (JP) 2010-021745

(51) Int. Cl. H05B 6/80

(52) U.S. Cl. 219/688

(57) ABSTRACT

High frequency microwaves and stem are supplied to a heating chamber (20) disposed inside the disclosed high frequency cooking device (1). On the floor of the heating chamber is formed a funnel-shaped slope (28), at the bottom of which is formed a condensate drain (27). A rotation shaft (31d) for transmitting rotation to a turn table (30) passes through the condensate drain. A cup-shaped support base (33) supporting a motor (32) for rotating the rotation shaft catches the condensate flowing out of the condensate drain. A drain pipe (36) forming part of the drain path (37) is connected to a drain (35) of the support base. A U-shaped bend (36a) formed in the drain pipe constitutes a water-sealing unit (39) where condensate accumulates.

### TECHNICAL FIELD

The present invention relates to microwave cooking devices that are capable of cooking by steam.

### BACKGROUND ART

Microwave cooking devices heat food from within by oscillating the molecules of the food with microwaves (high frequency electromagnetic waves). These cooking devices are generally called “microwave ovens” and are today indispensable in households. Some microwave cooking devices are furnished with a mechanism to supply steam into the heating chamber so as to be capable of steam-cooking using steam and combined use of microwaves and steam. An example is seen in Patent Document 1 listed below.

### LIST OF CITATIONS

### Patent Literature

Patent Document 1: JP-A-2008-32294

### SUMMARY OF INVENTION

### Technical Problem

When steam is used in a microwave cooking device, the steam condenses inside the heating chamber to produce condensate, of which the disposal poses a problem. One solution is to add a heater to heat the heating chamber to vaporize the condensate back into the gas phase. This approach, however, is not believed to be quite preferable because it increases the number of components and hence increases the manufacturing cost, and in addition increases the power consumption. Proper drainage of the condensate is the best approach to a feasible solution.

The aim of using steam in cooking is to replace the air inside the heating chamber with steam to lower the oxygen concentration there, in order to lessen oxidation-induced degradation in taste. When a condensate drain port is formed in the heating chamber, it can be used as an exhaust port for air; as the replacement of air with steam progresses, however, it becomes necessary to prevent leakage of steam and entry of outside air through the condensate drain port.

The present invention has been made against the above background, and a main object of the invention is to provide, for microwave cooking devices capable of cooking by steam, a mechanism that allows reliable drainage of condensate out of the heating chamber but that nevertheless is free from leakage of steam and entry of outside air during cooking.

### Solution to Problem

To achieve the above object, according to the invention, a microwave cooking device which is adapted to be capable of supplying steam into a heating chamber inside the device is characterized in that: a condensate drain port is formed in the bottom wall of the heating chamber, and a water-seal portion which keeps condensate is formed in a drain passage which starts at the condensate drain port.

According to the invention, in the microwave cooking device constructed as described above, a funnel-shaped slope is formed in the bottom wall of the heating chamber, and the condensate drain port is arranged in the lowest part of the slope.

According to the invention, in the microwave cooking device constructed as described above, a turntable on which an object to be heated is placed is arranged inside the heating chamber, and a rotary shaft which transmits rotation to the turntable penetrates the condensate drain port.

According to the invention, in the microwave cooking device constructed as described above, a cup-shaped support base is fixed on the outer face of the bottom wall of the heating chamber, the support base supports a motor which gives rotation to the rotary shaft, and the support base collects condensate that flows out through the condensate drain port.

According to the invention, in the microwave cooking device constructed as described above, a drain pipe which constitutes part of the drain passage is connected to a drain port which is formed in the support base, and a bend which is formed as a part of the drain pipe constitutes the water-seal portion.

According to the invention, in the microwave cooking device constructed as described above, a drain pan is arranged where the drain passage ends.

### Advantageous Effects of the Invention

According to the present invention, the condensate produced inside the heating chamber during steam cooking is reliably drained through the condensate drain port formed in the bottom wall of the heating chamber. The drain passage which starts at the condensate drain port has a part of it formed into the water-seal portion in which the condensate keeps. Thus, when the air inside the heating chamber is replaced with steam and the oxygen concentration there lowers, and as a result the steam starts to condense, the flow of steam in the gas phase is blocked by the water-seal portion. Also if outside air tends to enter, it is blocked by the water-seal portion. Thus, during steam cooking, steam is enclosed inside the heating chamber so as to keep a low-oxygen condition and to continue to be used to heat food. In this way, it is possible to prevent oxidation-induced degradation in taste. Moreover, the energy used to generate steam is not wasted, and thus it is possible to perform cooking with improved energy efficiency. Drainage of condensate without passage of steam is achieved by means of a simple mechanism, that is, the water-seal portion, and thus no complicated mechanism needs to be adopted as would lead to increased cost.

### BRIEF DESCRIPTION OF DRAWINGS

FIG. 1 is a perspective view of a microwave cooking device embodying the invention;

FIG. 2 is a vertical sectional view showing an outline of the construction inside the microwave cooking device;

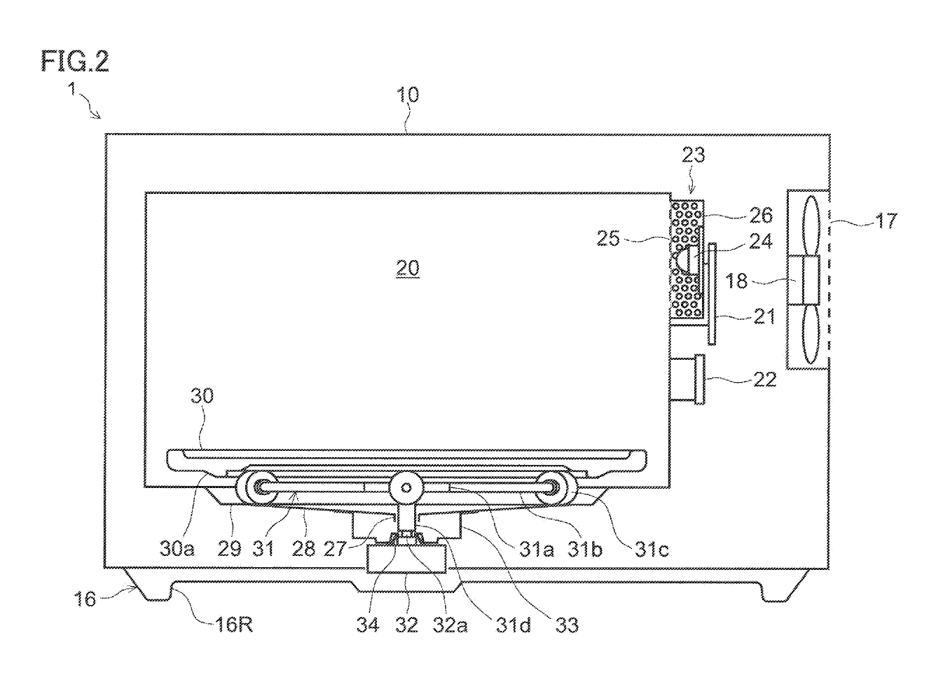

FIG. 3 is a side exterior view of a heating chamber inside the microwave cooking device;

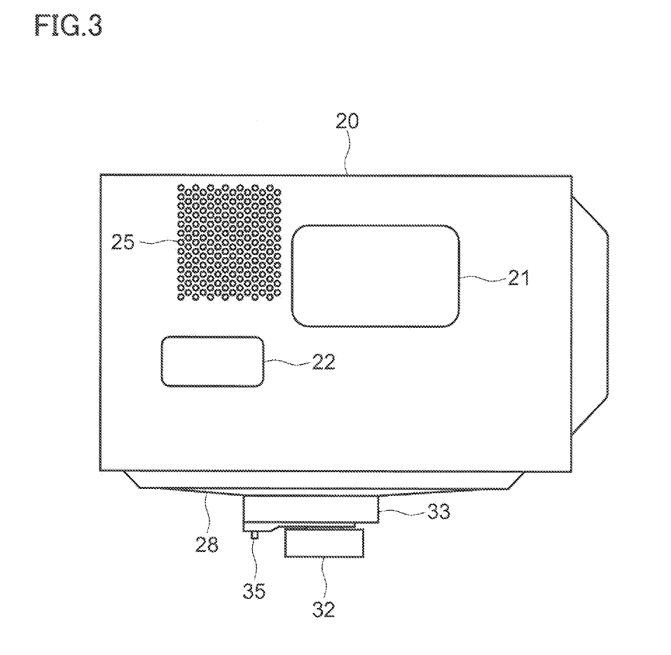

FIG. 4 is a partial vertical sectional view showing the structure of a bottom part of the heating chamber;

FIG. 5 is a top view of the bottom part of the heating chamber; and

FIG. 6 is a block configuration diagram of the microwave cooking device.

### DESCRIPTION OF EMBODIMENTS

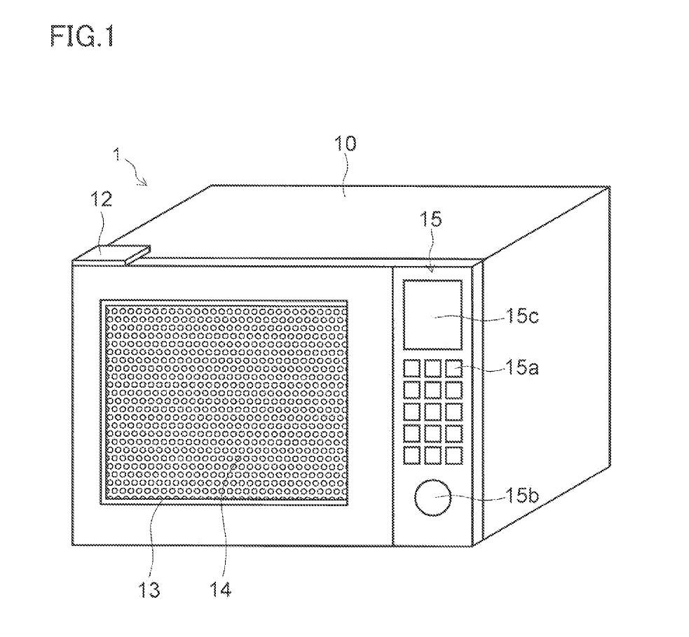

The construction of a microwave cooking device 1 embodying the invention will be described below with reference to the accompanying drawings. In FIG. 1, the top and bottom of the page coincide with the top and bottom of the microwave cooking device 1; moreover, it is assumed that the left and right sides of the page correspond to the left and right sides, respectively, of the microwave cooking device 1.

The microwave cooking device 1 has a cabinet 10 which is a structural member formed of sheet metal in the shape of a rectangular parallelepiped. Inside the cabinet 10, a heating chamber 20 is provided which is a structural member formed of sheet metal in the shape of a rectangular parallelepiped smaller than the cabinet 10. The heating chamber 20 has an opening at the front of the cabinet 10. At the front of the cabinet 10, a metal door 11 is provided by which the opening of the heating chamber 20 is opened and closed. The door 11 is, at its left end, coupled to the cabinet 10 via a hinge 12 so as to be swingable about the hinge 12 in the horizontal plane.

The door 11 has a window 13 formed in it which permits a view inside the heating chamber 20. The window 13 is fitted with a door screen 14 composed of a sheet of punched sheet metal held between two glass plates. This provides an inside view while preventing leakage of electromagnetic waves. The door 11 is provided with, in addition to the door screen 14, further means for preventing leakage of electromagnetic waves, is fitted with a gasket for preventing leakage of steam, and is furnished with a locking device for keeping a closed state. These all belong to well-known technologies, and therefore will not be discussed in detail.

In a part of the cabinet 10 to the right of the door 11, an operation panel 15 is provided. On the operation panel 15 are arranged, as members constituting an operation interface, a set of membrane switches 15a and a dial 15b. Over the membrane switches 15a, a display device 15c is arranged which includes a liquid crystal panel.

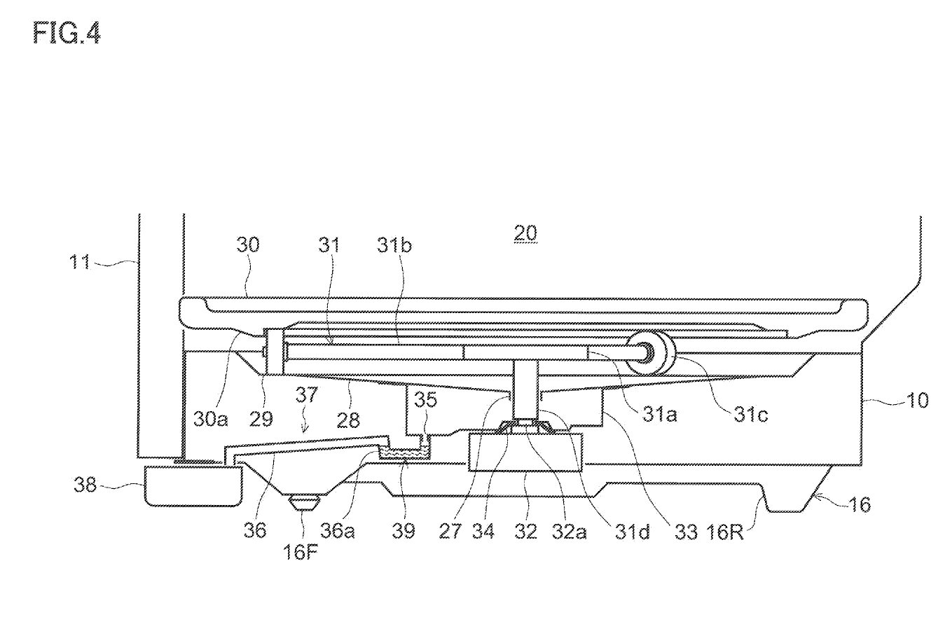

The cabinet 10 is supported on a table or a stand via a base 16. The base 16 has front feet 16F (see FIG. 4) at two, left and right, places at the front and rear feet 16R at two, left and right, places at the rear. The rear feet 16R have a fixed height; by contrast, the front feet 16F allow adjustment of their height by means of a screw-based mechanism. Adjusting the height of the front feet 16F allows the cabinet 10 to be kept level.

The construction inside the microwave cooking device 1 will now be described. On the outer face of the right side wall of the heating chamber 20, there are mounted a microwave generating device (magnetron) 21 and a steam generating device 22. The microwave generating device 21 supplies microwaves into the heating chamber 20, and the steam generating device 22 supplies steam into the heating chamber 20. The microwave generating device 21 and the steam generating device 22 are located in a space inside the cabinet 10 behind the operation panel 15. In the same space, a circuit board (not shown) is also arranged which constitutes a control device, which will be described later.

On the outer face of the right side wall of the heating chamber 20, an illumination device 23 is also arranged which illuminates inside the heating chamber 20. The illumination device 23 includes a light emitting diode (LED) as a light source. In the right side wall of the heating chamber 20, a large number of light passing perforations 25 are formed in a rectangular array to let through the light from the LED 24. The light passing perforations 25 are sized and arrayed like the perforations in the punched sheet metal of the door screen 14, so that no radio waves leak through them.

The array of light passing perforations 25 is covered, from outside the heating chamber 20, with a cover 26 in the shape of a rectangular parallelepiped. The cover 26 encloses the LED 24, and serves as a mounting base for the LED 24. The cover 26 is formed of punched sheet metal to let through air to cool the LED 24.

In the right side face of the cabinet 10, an exhaust port 17 is formed which is an array of small perforations, and inside the exhaust port 17, a cooling fan 18 is arranged. When the cooling fan 18 is operated, the air inside the cabinet 10 is exhausted through the exhaust port 17. As a result, through a suction port (not shown) provided somewhere else in the cabinet 10, air outside the microwave cooking device 1 is sucked in. The air sucked in flows toward the cooling fan 18. The flow of the air cools heat-generating components such as the microwave generating device 21, the LED 24, and the circuit board.

In the bottom wall of the heating chamber 20, a condensate drain port 27 is formed for draining condensate resulting from steam forming dew. In the bottom wall of the heating chamber 20, a funnel-shaped slope 28 is formed which descends toward its center. In the lowest part of the slope 28, the condensate drain port 27 is arranged.

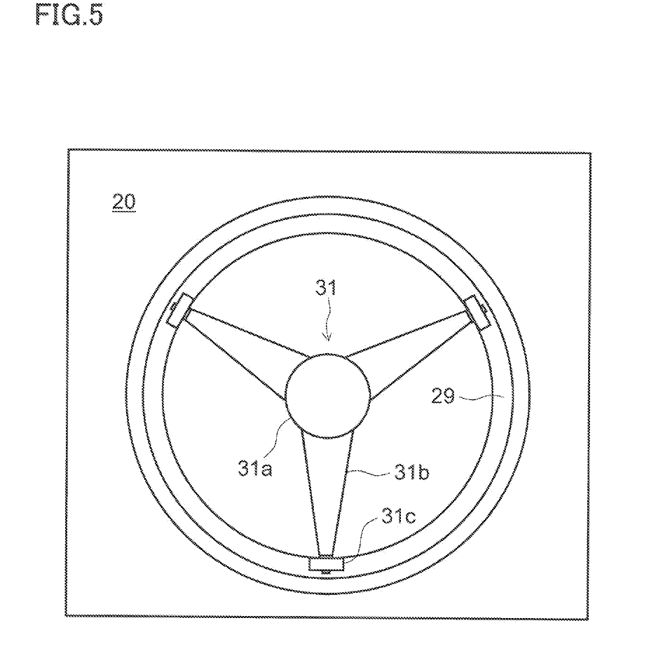

In the heating chamber 20, a turntable 30 is arranged on which a food item as an object to be heated is placed. The turntable 30 is a glass member circular in shape as seen in a plan view, and has a slightly depressed top face like a dish. The turntable 30 is supported on the bottom wall of the heating chamber 20 via a roller stay 31. As shown in FIG. 5, the roller stay 31 is composed of a hub 31a at the center, three arms 31b radially protruding from it at angular intervals of 120 degrees, and rollers 31c rotatably held at the tip end of them respectively. The rollers 31c make contact with, at one side, a ring-shaped track surface 29 surrounding the slope 28 and, at the other side, the bottom face of the turntable 30 to bear the weight of the turntable 30 and the food item. To prevent the turntable 30 from deviating from the roller stay 31, on the bottom face of the turntable 30, a ring-shaped rib 30a is formed so as to surround the three rollers 31c.

The roller stay 31 receives rotation via a rotary shaft 31d. The rotary shaft 31d is molded integrally with the hub 31a so as to extend down from it. The rotary shaft 31d vertically penetrates the condensate drain port 27. Between the outer face of the rotary shaft 31d and the inner face of the condensate drain port 27, a gap is provided which allows passage of drips of water. The rotary shaft 31d protrudes down from the bottom wall of the heating chamber 20, and is unrotatably coupled to an output shaft 32a of a motor 32.

The motor 32 is of a vertical-shaft type, and is supported on the heating chamber 20 via a cup-shaped support base 33 fixed on the outer face of the bottom wall of the heating chamber 20. The motor 32 incorporates a reduction mechanism, and rotates the output shaft 32a at reduced speed. Where the output shaft 32a penetrates the support base 33, a sealing member 34 is arranged which prevents leakage of water out of the support base 33 toward the motor. The support base 33 is at its top end welded to the bottom wall of the heating chamber 20 with intimate contact between them, so that no water or steam leaks there.

The support base 33 serves to collect water that flows out through the condensate drain port 27. As shown in FIG. 4, the bottom face of the support base 33 is lowest in its part facing the door 11, and there a drain port 35 is formed.

To the drain port 35, the inlet of a drain pipe 36 is connected. The support base 33 and the drain pipe 36 together constitute a drain passage 37 which starts at the condensate drain port 27 and ends at the outlet of the drain pipe 36. Where the drain passage 37 ends, a drain pan 38 is arranged. The drain pan 38 is removably supported on the cabinet 10, and can be detached and attached through under the door 11.

The drain pipe 36 gradually descends from inlet to outlet, and a part of it near the inlet is formed into a U-shaped bend 36a. The bend 36a constitutes a water-seal portion 39 that keeps condensate. The drain pipe 36 may be a pipe of a hard synthetic resin, or a tube or hose of a soft material.

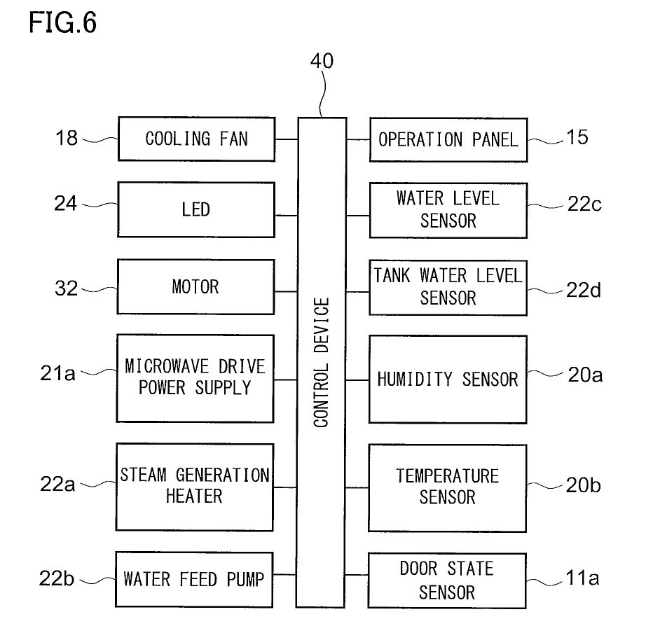

The controlling components of the microwave cooking device 1 are shown in FIG. 6. The overall control is assumed by a control device 40. To the control device 40 are connected, among the components already mentioned, the operation panel 15, the cooling fan 18, the LED 24, and the motor 32. In addition, the following components are also connected to the control device 40: a microwave drive power supply 21a which enables the microwave generating device 21 to perform microwave oscillation; a steam generation heater 22a incorporated in the steam generating device 22; a water feed pump 22b appended to the steam generating device 22; a water level sensor 22c incorporated in the steam generating device 22; a tank water level sensor 22d incorporated in a water tank (not shown) appended to the steam generating device 22; a humidity sensor 20a and a temperature sensor 20b provided in the heating chamber 20; and a door state sensor 11a provided for the door 11 to check whether it is open or closed.

The microwave cooking device 1 operates as follows. To perform heating by microwaves, the user puts a food item as an object to be heated on the turntable 30, closes the door 11, and presses, among the membrane switches 15a on the operation panel 15, one for “microwave cooking.” If secure closure of the door 11 is detected by the door state sensor 11a, the microwave drive power supply 21a is energized, and the microwave generating device 21 starts microwave oscillation. Thus, the food item in the heating chamber 20 is heated by microwaves.

When the microwave generating device 21 is energized, the cooling fan 18, the LED 24, and the motor 32 are also energized. The cooling fan 18 produces a stream of air, and with it cools the heat-generating components in the cabinet 10. The LED 24 illuminates inside the heating chamber 20. The motor 32 rotates the output shaft 32a, which rotates the roller stay 31.

As the roller stay 31 rotates, the rollers 31c with the turntable 30 supported on them roll on the track surface 29. The rolling rollers 31c further thrust the turntable 30 placed on them in the rotating direction. Thus, the turntable 30 rotates at twice the angular velocity of the rollers 31c.

On passage of a predetermined length of time, or in response to an operation by the user, or on detection of the food temperature having reached a predetermined level by a sensor specially provided for that purpose, the control device 40 stops energizing the microwave drive power supply 21a, the cooling fan 18, the LED 24, and the motor 32 to end cooking by microwave heating. The user opens the door 11, and takes the food item out. It is also possible to adopt a configuration in which for a predetermined length of time after the end of cooking by microwave heating, the cooling fan 18 continues to operate to keep cooling the heated components.

To perform cooking by combined use of microwaves and steam, the user puts a food item as an object to be heated on the turntable 30, closes the door 11, and presses, among the membrane switches 15a on the operation panel 15, one for “microwave-and-steam cooking.” If secure closure of the door 11 is detected by the door state sensor 11a, the water feed pump 22b is energized, and water is fed from a water tank to the steam generating device 22. When the water level inside the steam generating device 22 is found to have reached a predetermined level by the water level sensor 22c, the water feed pump 22b stops operating. When, through evaporation, the water level inside the steam generating device 22 becomes so low as to require a new supply of water, the water feed pump 22b starts to operate again.

When the steam generating device 22 is supplied with so much water that the water level inside it reaches a predetermined level, the steam generation heater 22a is energized, and the water inside the steam generating device 22 is heated. When the water boils and steam starts to be supplied to the heating chamber 20, the control device 40 starts microwave heating. The control device 40 recognizes the start of the supply of steam to the heating chamber 20 on passage of a predetermined length of time after the start of the energizing of the steam generation heater 22a, or on detection of the humidity inside the heating chamber 20 having raised to a predetermined level by the humidity sensor 20a, or on detection of the temperature inside the heating chamber 20 having raised to a predetermined level by the temperature sensor 20b. When microwave heating starts, the microwave drive power supply 21a, the cooling fan 18, the LED 24, and the motor 32 are energized. The LED 24 may be lit at an earlier stage.

As steam fills the heating chamber 20, the air inside the heating chamber 20 is removed out of the heating chamber 20. The condensate drain port 27 serves as one exhaust port for air. As air is replaced with steam, the oxygen concentration inside the heating chamber 20 lowers. Cooked in such a low-oxygen atmosphere, food suffers less from oxidation-induced degradation in taste, and thus the user can have satisfactory cooking results.

On passage of a predetermined length of time, or in response to an operation by the user, or on detection of the food temperature having reached a predetermined level by a sensor specially provided for that purpose, the control device 40 stops energizing the microwave drive power supply 21a, the cooling fan 18, the LED 24, the motor 32, and the steam generation heater 22a to end cooking by combined use of microwaves and stream. The user opens the door 11, and takes the food item out.

The steam from the steam generating device 22 alone, without microwaves, may be used to perform steam-cooking. In that case, there is little need to rotate the turntable 30, and accordingly the control device 40 keeps the motor 32 at a standstill. The cooling fan 18, on the other hand, needs to cool the LED 24 and also to prevent the interior of the cabinet 10 from becoming too hot from the heat generated by the steam generating device 22; thus, the control device 40 operates the cooling fan 18 as usual.

Irrespective of whether cooking is performed by combined use of microwaves and steam or steam-cooking is performed by steam alone, when cooking proceeds by use of steam with the air inside the heating chamber 20 replaced with steam and thus under low-oxygen-concentration condition, steam in contact with the inner wall faces of the heating chamber 20, the turntable 30, and the roller stay 31 condenses to form condensate. The condensate drips onto the bottom wall of the heating chamber 20. The condensate that has dripped onto the bottom wall moves along the slope 28 to a central part of the heating chamber 20, and flows out through the condensate drain port 27. The condensate will then flow down the drain passage 37.

The condensate that has flowed down through the condensate drain port 27 is collected in the support base 33, and is drained through the drain port 35. The condensate that has flowed out through the drain port 35 proceeds to flow through the drain pipe 36, where the bend 36a keeps condensate and thereby seals the drain pipe 36. Thus, the water-seal portion 39 is formed here. The flow of steam in the gas phase is blocked by the water-seal portion 39; also if outside air tends to enter, it is blocked by the water-seal portion 39.

Thus, during steam cooking, steam is enclosed inside the heating chamber 20 so as to keep a low-oxygen condition and to continue to be used to heat food. In this way, it is possible to prevent oxidation-induced degradation in taste. Moreover, the energy used to generate steam is not wasted, and thus it is possible to perform cooking with improved energy efficiency. Drainage of condensate without passage of steam is achieved by means of a simple mechanism, that is, the water-seal portion 39, and thus no complicated mechanism needs to be adopted as would lead to increased cost.

When condensate overflows out of the bend 36a, it flows down the drain pipe 36 and, where it ends, flows out of the drain passage 37 into the drain pan 38. Taking notice of the condensate collecting in the drain pan 38, the user, as necessary, pulls out the drain pan 38 and clears it of its contents while the microwave cooking device 1 is out of operation. The user then puts the drain pan 38 back in position in preparation for steam cooking next time.

In the construction according to the embodiment, in the bottom wall of the heating chamber 20, the funnel-shaped slope 28 is formed and, in the lowest part of the funnel-shaped slope 28, the condensate drain port 27 is arranged. Thus, the condensate left after steam-cooking using steam can be collected from over a wide area and be disposed of reliably. This facilitates the cleaning after steam-cooking. The rotary shaft 31d which transmits rotation to the turntable 30 on which an object to be heated is placed penetrates the drain port 27, and thus there is no need to separately provide a through hole in the bottom wall of the heating chamber 20 to put the rotary shaft 31d through. This helps simplify the construction and reduce the manufacturing cost. Condensate left collected under the turntable 30 leads to hygienic problems; the construction according to the embodiment, however, is free from such concerns.

On the outer face of the bottom wall of the heating chamber 20, the cup-shaped support base 33 is fixed, and this support base 33 supports the motor 32 which gives rotation to the rotary shaft 31d, and in addition collects the condensate flowing out through the condensate drain port 27. Thus, it is possible to reliably prevent energized parts of electric components from becoming wet with condensate, and thus to achieve enhanced safety. Moreover, the support base 33 serving both to support the motor 32 and to collect condensate helps reduce the number of components needed and hence reduce the manufacturing cost.

To the drain port 35 formed in the support base 33, the drain pipe 36 which constitutes part of the drain passage 37 is connected, and the bend 36a formed as a part of the drain pipe 36 constitutes the water-seal portion 39. Thus, it is possible to form the water-seal portion 39 easily. Moreover, where the drain passage 37 ends, the drain pan 38 is arranged. Thus, it is possible to dispose of condensate easily so as not to incur an unhygienic condition.

The water-seal portion 39 may be formed by any other means than the bend 36a formed in the drain pipe 36; any structure may instead be used so long as it acts as a water-seal portion that keeps water somewhere within it in such a way that the water stops the drain pipe 36.

The embodiment by way of which the invention has been specifically described above is in no way meant to limit the scope of the invention; in implementing the invention, many modifications and variations are possible within the spirit of the invention.

### INDUSTRIAL APPLICABILITY

The present invention finds wide application in microwave cooking devices that are capable of cooking by steam.

### LIST OF REFERENCE SIGNS

1 microwave cooking device
10 cabinet
11 door
15 operation panel
20 heating chamber
21 microwave generating device
22 steam generating device
27 condensate drain port
28 slope
30 turntable
31 roller stay
31d rotary shaft
32 motor
33 support base
35 drain port
36 drain pipe
36a bend
37 drain passage
38 drain pan
39 water-seal portion

1. A microwave cooking device which is adapted to be capable of supplying steam into a heating chamber inside the device, wherein
a condensate drain port is formed in a bottom wall of the heating chamber, and
a water-seal portion which keeps condensate is formed in a drain passage which starts at the condensate drain port.

2. The microwave cooking device according to claim 1, wherein
a funnel-shaped slope is formed in the bottom wall of the heating chamber, and
the condensate drain port is arranged in a lowest part of the slope.

3. The microwave cooking device according to claim 1, wherein
a turntable on which an object to be heated is placed is arranged inside the heating chamber, and
a rotary shaft which transmits rotation to the turntable penetrates the condensate drain port.

4. The microwave cooking device according to claim 3, wherein
a cup-shaped support base is fixed on an outer face of the bottom wall of the heating chamber,
the support base supports a motor which gives rotation to the rotary shaft, and
the support base collects condensate that flows out through the condensate drain port.

5. The microwave cooking device according to claim 4, wherein
a drain pipe which constitutes part of the drain passage is connected to a drain port which is formed in the support base, and
a bend which is formed as a part of the drain pipe constitutes the water-seal portion.

6. The microwave cooking device according to claim 1, wherein
a drain pan is arranged where the drain passage ends.

7. The microwave cooking device according to claim 2, wherein
a drain pan is arranged where the drain passage ends.

8. The microwave cooking device according to claim 3, wherein
a drain pan is arranged where the drain passage ends.

9. The microwave cooking device according to claim 4, wherein
a drain pan is arranged where the drain passage ends.

10. The microwave cooking device according to claim 5, wherein
a drain pan is arranged where the drain passage ends.
